(19) United States
(12) Patent Application Publication
(10) Pub. No.: US 2024/0213880 A1
(43) Pub. Date: Jun. 27, 2024

(54) METHODS AND APPARATUS TO CALIBRATE MULTIPHASE BUCK REGULATORS

(71) Applicant: Texas Instruments Incorporated, Dallas, TX (US)

(72) Inventors: Vikas Lakhanpal, Bengaluru (IN); Preetam Charan Anand Tadeparthy, Bengaluru (IN); Sreelakshmi S, Bengaluru (IN); Mayank Jain, Bengaluru (IN); Charan Hemanth Kumar, Bangalore (IN)

(21) Appl. No.: 18/140,418

(22) Filed: Apr. 27, 2023

(30) Foreign Application Priority Data
Dec. 22, 2022 (IN) 202241074395

(51) Int. Cl. H02M 3/158

(52) U.S. Cl. CPC H02M 3/1586

(57) ABSTRACT

An example non-transitory machine-readable storage medium includes instructions that, when executed, configure processor circuitry to at least: determine a first delay corresponding to an amount of time for a first pulse to reach first phase circuitry; determine a second delay corresponding to an amount of time for a second pulse to reach second phase circuitry; determine a third delay corresponding to an amount of time for a third pulse to reach third phase circuitry, wherein one or more of the first phase circuitry, the second phase circuitry, and the third phase circuitry are located a non-uniform distance from the processor circuitry; and transmit, based on the delays, the pulses to the respective phase circuitry such that a first time period between the first pulse and the second pulse is equal to a second time period between the second pulse and the third pulse.

### CROSS-REFERENCE TO RELATED APPLICATION

This patent application claims the benefit of and priority to Indian Provisional Patent Application Serial No. 202241074395 filed Dec. 22, 2022, which Application is hereby incorporated herein by reference in its entirety.

### TECHNICAL FIELD

This description relates generally to buck regulators, and more particularly to methods and apparatus to calibrate multiphase buck regulators.

### BACKGROUND

Power management circuitry is a critical design component of any electronic device. In general, power management circuitry refers to hardware and/or software that converts a first amount of power (e.g., a first voltage and/or current) received from a source into a second amount of power (e.g., a second voltage and/or current) that is consumable by a load. Power sources may include, but are not limited to, 120 volts alternating current (VAC) or 240 VAC wall outlets, batteries, generators, power provided by solar cells, etc. Generally, power management circuitry may additionally convert the power from a first type (e.g., alternating current (AC)) to a second type (e.g., direct current (DC)) that is usable by the load.

### SUMMARY

For methods and apparatus to calibrate multiphase buck regulators, an example non-transitory machine-readable storage medium includes instructions that, when executed, configure processor circuitry to at least: determine a first delay corresponding to an amount of time for a first pulse to reach first phase circuitry; determine a second delay corresponding to an amount of time for a second pulse to reach second phase circuitry; determine a third delay corresponding to an amount of time for a third pulse to reach third phase circuitry, wherein one or more of the first phase circuitry, the second phase circuitry, and the third phase circuitry are located a non-uniform distance from the processor circuitry; and transmit, based on the delays, the pulses to the respective phase circuitry such that a first time period between the first pulse and the second pulse is equal to a second time period between the second pulse and the third pulse.

### BRIEF DESCRIPTION OF THE DRAWINGS

FIG. 1 is an example block diagram of a compute environment.

FIG. 2 is an example block diagram of the multi-phase buck regulator circuitry of FIG. 1.

FIG. 3 is an illustrative example of the multi-phase buck regulator circuitry of FIG. 1.

FIG. 4 is a first example timing diagram of operations performed by the multi-phase buck regulator circuitry of FIG. 1.

FIG. 5 is a second example timing diagram of operations performed by the multi-phase buck regulator circuitry of FIG. 1.

FIG. 6 is a first timing diagram of operations performed by previous solutions and a third example timing diagram of operations performed by the multi-phase buck regulator circuitry of FIG. 1.

FIG. 7 is a fourth example timing diagram of operations performed by the multi-phase buck regulator circuitry of FIG. 1.

FIG. 8 is a fifth example timing diagram of operations performed by the multi-phase buck regulator circuitry of FIG. 1.

FIG. 9 is a sixth example timing diagram of operations performed by the multi-phase buck regulator circuitry of FIG. 1.

FIG. 10 is a flowchart representative of an example process that may be performed using machine-readable instructions that can be executed and/or hardware configured to implement the pulse calibrator circuitry of FIG. 2, and/or, more generally, the muti-phase buck regulator circuitry of FIG. 1.

FIG. 11 is a flowchart representative of an example process that may be performed using machine-readable instructions that can be executed and/or hardware configured to determine transmission times as described in connection with FIG. 10.

FIG. 12 is a flowchart representative of an example process that may be performed using machine-readable instructions that can be executed and/or hardware configured to adjust Pulse Width Modulation (PWM) delay times.

FIG. 13 is a block diagram of an example processing platform including processor circuitry structured to execute the example machine-readable instructions and/or the example operations of FIG. 9 to implement the controller circuitry of FIG. 2.

The same reference numbers or other reference designators are used in the drawings to designate the same or similar (functionally and/or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

Power management circuitry can refer to a wide variety of circuit architectures that implement different functionalities. One such example of power management circuitry are voltage regulators. Voltage regulators refer to a category of circuit architectures designed to provide a constant voltage to a load. One example implementation of a voltage regulator is a buck regulator circuit that is designed to accept a first DC voltage from a supply and output a lower, second DC voltage to a load. Buck regulator circuits can also provide increased current at the second DC voltage compared to the current that can be provided at the first DC voltage. In some examples, buck regulators are referred to as buck converters.

Buck regulator circuits generally include, at a minimum, an inductor and a set of switches rated for high current and high voltage applications (e.g., a power metal-oxide-semiconductor field-effect transistor (MOSFET)). In some examples, an inductor and the corresponding power MOSFETs are referred to as either a power stage circuit or a phase circuit.

Generally, buck regulator circuits were traditionally implemented using single-phase designs. In such a design, one inductor and the corresponding power MOSFETs provide all the power required by the load. However, the increasing complexity and functionality of electronic devices has led to loads requiring larger amounts of power than previous generations of devices. In response, industry members have developed and adopted multi-phase buck regulator circuits having multiple inductors and multiple sets of corresponding power MOSFETs. Multi-phase buck regulator circuits can provide high power signals to a load while exhibiting reduced input capacitance, reduced output capacitance, improved thermal performance, and improved transient response in comparison to single-phase buck regulator circuits.

In a multi-phase buck regulator architecture, a controller circuit sends pulses to one or more phases, enabling the one or more phases to concurrently provide a desired voltage and a desired current to a load. The timing of a transmission between two pulses sent to two different phases is a key factor in the performance and efficiency of the multi-phase buck regulator circuit. For example, a controller circuit of a-multiphase buck regulator may transmit pulses according to a timing scheme that evenly balances current supplied by active phase circuits. By doing so, the controller circuit avoids thermally stressing any one phase circuit and provides optimal ripple cancellation. In some examples, pulses sent from a controller circuit to a phase are referred to as instructions.

To enable a timing scheme between phase pulses that optimizes performance, previous multi-phase buck regulator architecture solutions were implemented on a printed circuit board (PCB) such that the controller circuit is approximately equidistant to all phase circuits. As such, previous solutions of controller circuits were designed with the assumption that if n instructions were simultaneously sent to n phase circuits, each of the n instructions would arrive at the respective phase circuit at approximately the same time.

Previously, multi-phase buck regulator architectures typically implemented between two to eight phase circuits, a sufficiently low number that enabled each phase circuit to be implemented equidistant from the controller circuit on a PCB. However, the increased power requirements of electronic devices have led to a need for multi-phase buck regulator architectures with more phase circuits. In some examples, a multi-phase buck regulator may include twelve or more phase circuits. While the number of desired phase-buck regulators increases, the size of a PCB continues to be a developmental constraint. As a result, continually increasing the area of a PCB so that an increasing number of power phase circuits can be located equidistant from a controller is impractical. However, previous solutions of multi-phase buck regulators are unable to support PCBs where a first phase circuit is physically located farther away from the controller than a second phase circuit.

Example methods, apparatus, and systems herein describe example multi-phase buck regulator circuitry in which the phase circuits are not required to be implemented equidistant from the controller circuit. Advantageously, the example multi-phase buck regulator circuitry includes example controller circuitry that measures the delay between when a pulse is transmitted at the controller circuitry and when the current in the output signal of the corresponding phase circuit rises above a threshold. The example controller circuitry then calibrates the phase circuit by considering the delays of the other phase circuits and waiting to transmit a subsequent pulse. Further, the example controller circuitry re-calibrates a given phase circuit whenever the phase-circuit is reenabled to account for changes in temperature, voltage, aging, etc. The example controller circuitry also uses the delay of a similarly located phase circuit to estimate the delay of a phase circuit that has not yet been calibrated. As a result, the example multi-phase buck regulator circuitry can transmit pulses that arrive to phase circuits in an interleaved fashion, even when the phase circuits are not located equidistant from the controller circuit.

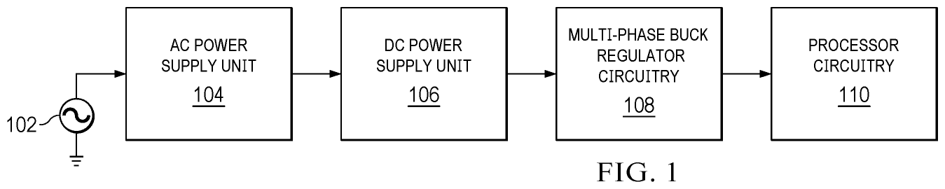

FIG. 1 is an example block diagram of a compute environment. The example environment 100 includes an example power source 102, an example AC power supply unit 104, an example DC power supply unit 106, example multi-phase buck regulator circuitry 108, and example processor circuitry 110.

The example power source 102 provides AC power to the example environment 100. The example power source 102 may be implemented by any device providing electrical energy in AC. For example, in FIG. 1, the example power source 102 is implemented by a 120 VAC outlet.

The example AC power supply unit 104 transforms the 120 VAC into a different AC signal that is operable upon by the DC power supply unit. In particular, the example AC power supply unit 104 may alter one or more of the voltage, frequency, shape of signal, number of phases, etc., depending on the type of the power source 102 and the requirements of the DC power supply unit.

The example DC power supply unit 106 transforms the AC signal received from the AC powers supply unit 104 into a DC signal. The example DC power supply unit 106 includes rectifier circuitry and filter circuitry to convert the AC signal to a DC signal. The example DC power supply unit 106 is configured to provide a DC signal at a voltage that is operable by the example multi-phase buck regulator circuitry 108. In some examples, the DC power supply unit 106 is referred to as a voltage source.

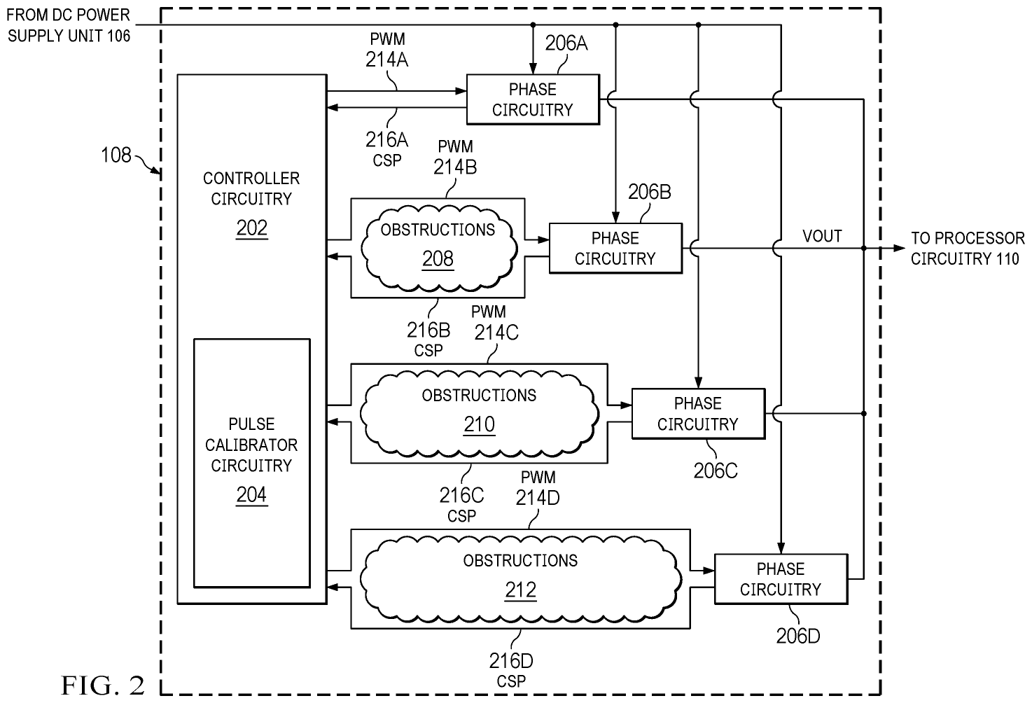

As described below, the example multi-phase buck regulator circuitry 108 is a voltage regulator circuit that transforms, in accordance with the teachings of this disclosure, the first DC voltage provided by the example DC power supply unit 106 into a second DC voltage usable by a load, such as processor circuitry 110. The example multi-phase buck regulator circuitry 108 is discussed further in connection with FIG. 2.

In FIG. 1, the example processor circuitry 110 is the load that uses the power from the second DC voltage to perform operations. In other examples, the load that receives the second DC voltage is another form of circuitry, including but not limited to a transceiver, volatile memory, etc. The example processor circuitry 110 may be implemented by any type of processor circuitry. Examples of processor circuitry 110 include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs).

FIG. 2 is an example block diagram of the voltage regulator circuitry of FIG. 1. The example multi-phase buck regulator circuitry 108 of FIG. 1 includes example controller circuitry 202, which includes example pulse calibrator circuitry 204. The example multi-phase buck regulator circuitry 108 also includes example phase circuitry 206A, 206B, 206C, 206D (collectively referred to as phase circuits 206), example obstructions 208, 210, 212, example pulse width modulation (PWM) signals 214A, 214B, 214C, 214D (collectively referred to as PWM signals 214), and example current sensing pin (CSP) signals 216A, 216B, 216C, 216D (collectively referred to as CSP signals 216).

The example controller circuitry 202 transmits the example PWM signals 214A, 214B, 214C, 214D to the phase circuitry 206A, 206B, 206C, 206D, respectively. A given PWM signal includes pulses (e.g., a transition from a low supply voltage to a high supply voltage and back to a low supply voltage) that, when received by a phase circuit, causes the phase circuit to temporarily increase the current and provide power to a load through an output voltage (VOUT) signal.

In some examples, the controller circuitry 202 may adjust the voltage and/or current of the VOUT signal based on the type of load exhibited by the processor circuitry 110. For example, suppose one or more components from the example environment 100 are implemented within a laptop. The example controller circuitry 202 may cause the example phase circuits 206 to provide more power in the VOUT signal when the laptop is in an active state (e.g., lid open and with several applications running) then when the laptop is in a sleep state (e.g., lid closed with several applications closed or idle). The example controller circuitry 202 may be implemented by any type of processor circuitry. In some examples, the controller circuitry 202 is implemented on a PCB as an independent integrated circuit (IC) that is soldered to the board.

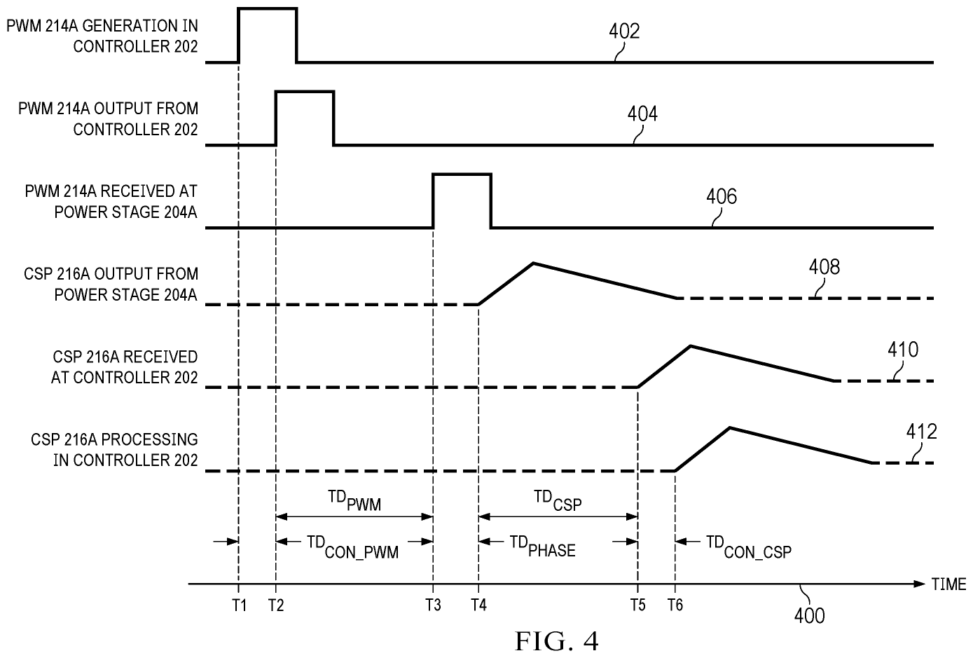

Within the example controller circuitry 202, the example pulse calibrator circuitry 204 determines when to transmit pulses in the PWM signals 214 in accordance with the teachings of this disclosure. In particular, the example pulse calibrator circuitry 204 measures the time delay of each PWM signal reaching its respective phase circuit and adjusts the timing of pulses based on the non-uniformity of the delays. The example pulse calibrator circuitry 204 is discussed further in connection with FIGS. 4-12.

Each of the example phase circuits 206 receives a constant input voltage from the example DC power supply unit 106 and a PWM signal from the controller circuitry 202. Upon receiving a pulse in the corresponding PWM signal 214A, a phase circuitry 206A increases the current and decreases the voltage of the VOUT signal. To perform the voltage and current transformation, each of the example phase circuits 206 may include an inductor and one or more switches rated for high power, as described previously.

The example phase circuitry 206A, 206B, 206C, 206D continuously transmit the CSP signals 216A. 216B, 216C, 216D, respectively, to the controller circuitry 202. The example CSP signals 216 describe the current flowing through the respective phases at any point in time. The controller circuitry 202 uses the CSP signals 216 to ensure the current flowing through any one phase stays below a limit. In some examples, the phase circuits 206 are implemented on a PCB as separate ICs that are each soldered to the board. While FIG. 2 illustrates four phase circuits for simplicity, in practice, the number of phase circuits may be greater. In some examples, the phase circuits 206 are referred to as power stage circuits.

The example obstructions 208, 210, 212 refer to portions of a PCB that physically exist in between the phase circuitry 206B, 206C. 206D, respectively, and the controller circuitry 202. The example obstructions 208, 210, 212 may be due to any type of material and structure associated with a PCB, including but not limited to other circuits, interconnects, and vias unrelated to the multi-phase buck regulator circuitry 108. The example obstructions 208, 210, 212 are not uniform in size or complexity and may be of any size that would result in various times of arrival between the controller circuitry 202 and the phase circuitry 206B-206D. In the example block diagram of FIG. 1, the obstructions 208, 210, 212 are sized such that a first interconnect that circumnavigates the obstruction 208 is shorter than a second interconnect that circumnavigates the obstruction 210, which in turn is shorter than a third interconnect that circumnavigates the obstruction 212. As a result, the PWM signal 214A has the shortest time of arrival to a phase circuit, the PWM signal 214B has the second shortest time of arrival, etc. Similarly, the CSP signal 216A has the shortest time of arrival to the controller circuitry 202, followed by the CSP signal 216B, etc.

Advantageously, the example controller circuitry 202 includes example pulse calibrator circuitry 204 that adjusts the pulses in the PWM signals 214A, 214B, 214C, 214D in view of the obstructions, 208, 210, 212. The ability of the example multi-phase buck regulator circuitry 108 to function with different distances between the phase circuits 206 and controller circuitry 202 enables the multi-phase buck regulator circuitry 108 to be included in more efficient and cost-effective PCB designs than previous solutions.

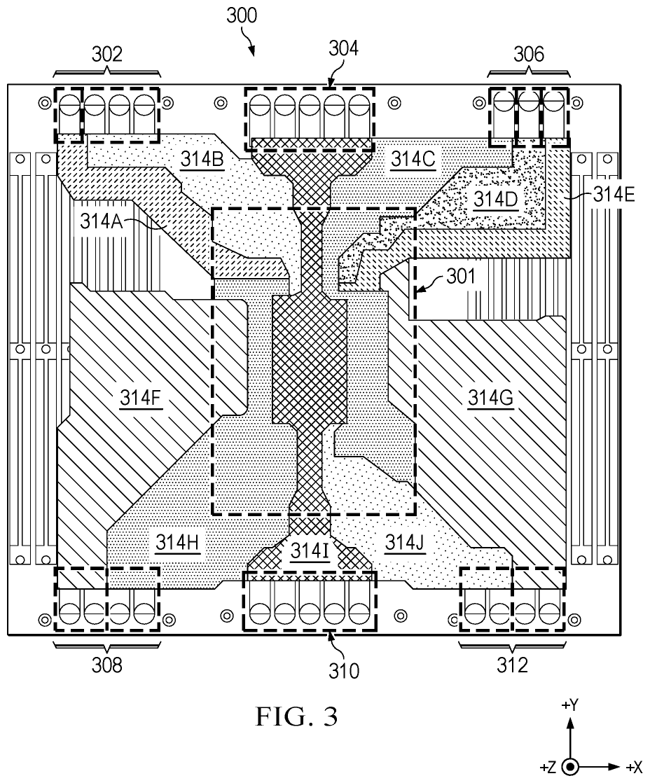

FIG. 3 is an illustrative example of the voltage regulator circuitry of FIG. 1. FIG. 3 illustrates an example PCB view 300. The example PCB view 300 includes an example controller region 301, example phase circuit regions 302, 304, 306, 308, 310, 312, and example interconnects 314A, 314B, 314C, 314D, 314E, 314E, 314F, 314G, 314H, 314I, and 314J (collectively referred to as interconnects 314).

The example PCB view 300 is a portion of a PCB layout that may be utilized to implement example multi-phase buck regulator circuitry in accordance with the teachings of this disclosure. In particular, the example PCB view 300 is one layer of the example PCB layout. When implemented, the complete PCB may include multiple layers that exist below (e.g., in the negative Z direction heading into the page) and/or above (e.g., in the positive Z direction heading out of the page) the layer illustrated in FIG. 3.

The center of the example PCB view 300 includes the controller region 301, which refers to the set of X-Y values where controller circuitry is implemented. The controller circuitry may be implemented on any Z value, including in one or more layers not illustrated in FIG. 3. Similarly, the example phase circuit regions 302, 304, 306, 308, 310, 312 refer to the set of X-Y values where phase circuits are implemented.

The example interconnects 314 refer to regions of metal used to transport signals within an IC. In particular, one or more of the example interconnects 314 include PWM signals and CSP signals. The example interconnects 314 are implemented at different lengths to reach both a phase circuit region and the controller region 301.

Unlike previous solutions, some of the example phase circuit regions 302, 304, 306, 308, 310, 312 are located on different sides of the controller region 301. In some use cases, utilizing PCB area on multiple sides of the controller region 301 allows for a greater number of phase circuits than PCBs that position all phase circuits on one side of the controller region 301. Advantageously, example multi-phase buck regulators described herein enable such PCB designs and the resulting increased functionality by supporting interconnects 314 with non-uniform length.

FIG. 4 is a first illustrative timing diagram of operations performed by the voltage regulator circuitry of FIG. 1. The example timeline 400 includes example signals 402, 404, 406, 408, 410, and 412 and timestamps T1, T2, T3, T4, T5, T6. The timestamps are ordered numerically such that T1 occurs before T2, which occurs before T3, etc.

The example timeline 400 demonstrates the various sources that exist between when the controller circuitry 202 determines to send a pulse in the example PWM signal 214A and when the controller circuitry 202 subsequently determines the current in the phase circuitry 206A has risen. For example, the signal 402 shows that at T1, the controller circuitry 202 determines to send a pulse in an example PWM signal 214A. However, the example signal 404 shows the rising edge of the pulse does not begin transmission (e.g., the voltage change does not appear on an output terminal of the controller circuitry) until T2. In general, the difference between T1 and T2 for any of the phase circuits 206 is caused by internal delays within the example controller circuitry 202 and is labelled in FIG. 2 as TD_{CON_PWM}. In some examples, TD_{CON_PWM}≈10 nanoseconds (ns).

The rising edge of the pulse begins transmission from the controller circuitry 202 at T2, but the example signal 406 shows the change in the PWM signal 214A is not received at the phase circuitry 206A until T3. In general, the difference between T2 and T3 for any of the phase circuits 206 is dependent on the length of the interconnects that couple the controller circuitry 202 to the particular phase circuit. The difference between T2 an T3 and is labelled in FIG. 2 as TD_{PWM}. In some examples, TD_{PWM} is within the range of [0 ns, 150 ns].

Upon arriving at the phase circuitry 206A, the pulse sent in the example PWM signal 214A causes the phase circuitry 206A to increase the current of the output signal above a threshold amperage. In turn, the example phase circuitry 206A proportionally increases the CSP signal 216A above a threshold voltage. However, the phase circuitry 206A requires an amount of time to increase the amperage from the steady state level that is output before the pulse to the threshold amperage level that is desired in response to the pulse. As a result, the example signal 408 shows that the CSP signal 216A does not rise above the threshold voltage until T4. In general, the difference between T3 and T4 for any of the phase circuits 206 is caused by internal delays within the phase circuit and is labelled in FIG. 2 as TD_{PHASE}. In some examples, TD_{PHASE} is within the range of [20 ns, 30 ns].

The example signal 410 shows that the change in the CSP signal 216A is not received at the controller circuitry 202 (e.g., a voltage at an input terminal of the controller circuitry 202 does not rise above the threshold voltage) until T5. In general, the difference between T4 and T5 for any of the phase circuits 206 is dependent on the length of the interconnects that couple the controller circuitry 202 to the particular phase circuit and is labelled in FIG. 4 as TD_{CSP}. In some examples, TD_{CSP} is within the range of [0 ns, 150 ns].

The example signal 412 shows that the controller circuitry 202 is not able to process (i.e., perform operations based on) the change in the CSP signal 216A until T6. In general, the difference between T5 and T6 for any of the phase circuits 206 is caused by internal delays within the example controller circuitry 202 and is labelled in FIG. 4 as TD_{CON_CSP}. In some examples, TD_{CON_CSP}≈10 ns.

FIG. 4 describes five sources of delay that contribute to the time difference between when the controller circuitry 202 determines to send a pulse in the PWM signal 214A and when the controller circuitry 202 processes the corresponding voltage increase in the CSP signal 216A. While not illustrated in FIG. 4 for simplicity, the time delay between a pulse sent to any of phase circuitry 206B, 206C, 206D and the subsequent processing of a CSP signal can be similarly divided into five sources. In some examples, the total amount of time from the five sources of delay is referred to as TD_{TOTAL}.

Of the five sources of delay, TD_{CON_PWM}, TD_{PHASE}, and TD_{CON_CSP} are deterministic values that can be calculated before the example controller circuitry 202 begins transmitting pulses. Additionally, all TD_{CON_PWM} measurements of the phase circuits 206 are approximately equal to one another, all TD_{PHASE} measurements of the phase circuits 206 are approximately equal to one another and all TD_{CON_CSP} measurements of the phase circuits 206 are approximately equal to one another. In contrast, TD_{PWM} and TD_{CSP} measurements will vary between phase circuits 206 because of the obstructions 208, 210, 212. Furthermore, in some examples, the multiphase buck regulator circuitry 108 is implemented with one or more of inequalities (a)-(f):

$$\begin{matrix}( a ) & T {D}_{PWM} ≫ {TD}_{CON\_PWM} \\ ( b ) & {TD}_{PWM} ≫ {TD}_{PHASE} \\ ( c ) & {TD}_{PWM} ≫ {TD}_{CON\_CSP} \\ ( d ) & {TD}_{CSP} ≫ {TD}_{CON\_PWM} \\ ( e ) & {TD}_{CSP} ≫ {TD}_{PHASE} \\ ( f ) & {TD}_{CSP} ≫ {TD}_{CON\_CSP}\end{matrix}$$

Advantageously, the example controller circuitry 202 includes example pulse calibrator circuitry 204. The example pulse calibrator circuitry 204 accurately measure TD_{PWM} and TD_{CSP} for each of the phase circuits 206 and considers all five sources of delay when determining when to transmit a given pulse. As a result, the example multi-phase buck regulator circuitry 108 can support a greater number of phase circuits and be implemented in more complex IC designs than previous solutions that assume TD_{PWM} and TD_{CSP} are equal between all phase circuits.

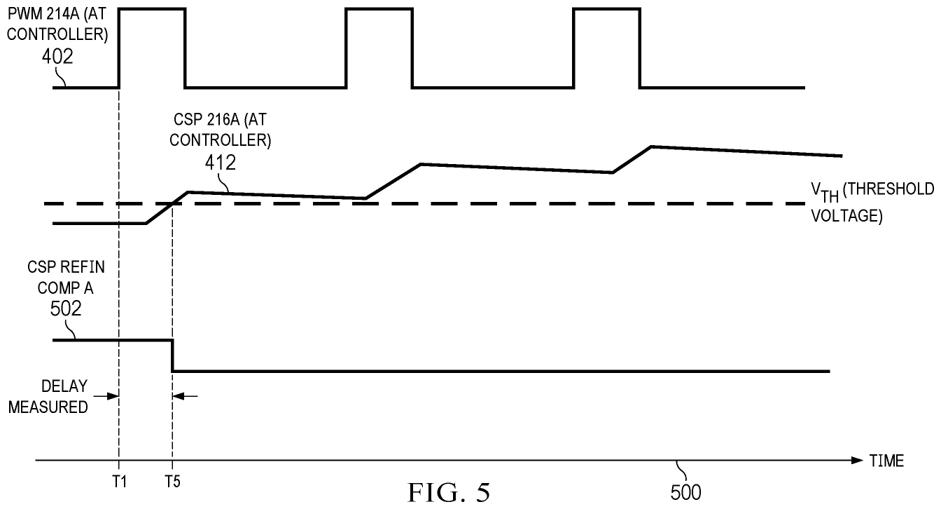

FIG. 5 is a second illustrative timing diagram of operations performed by the voltage regulator circuitry of FIG. 1. FIG. 5 includes an example timeline 500, which contains the example signals 402, 412, and an example signal 502. The example timeline 500 also includes timestamps T1 and T5, which correspond to the same points in time as T1 and T5 of the example timeline 400 of FIG. 4.

The example pulse calibrator circuitry 204 measures the delay between T1 and T5. For example, the pulse calibrator circuitry 204 may start a counter at T1, when the controller circuitry 202 first determines to transmit a rising edge of the pulse in the PWM signal 214A. The example pulse calibrator circuitry 204 may increment the counter for each clock cycle until T5, when the controller circuitry 202 determines that the CSP signal 216A has increased past a voltage threshold. FIG. 5 illustrates the counter stopping by the example signal 502 transitioning from a logical ‘1’ to a logical ‘0’.

In the foregoing example, the counter represents the TD_{TOTAL_A}, which is unique to the phase circuitry 206A. The example pulse calibrator circuitry 204 then adjusts TD_{TOTAL_A} to determine TD_{PWM_A} for the phase circuitry 206A. For example, the pulse calibrator circuitry may first subtract pre-determined values for TD_{CON_PWM}, TD_{PHASE}, and TD_{CON_CSP} so from TD_{TOTAL_A} so the remaining value is representative of TD_{PWM_A}+TD_{CSP_A}. The example pulse calibrator circuitry 204 may then divide the remaining value in half, utilizing the assumption that a signal travelling from the controller circuitry 202 to the phase circuitry 206A takes approximately the same amount of time as a signal traveling from the phase circuitry 206A to the controller circuitry 202. By adjusting the counter value, the example pulse calibrator circuitry 204 determines a value representative of TD_{PWM_A}. Similarly, the example pulse calibrator circuitry 204 uses the same adjustment technique described in FIG. 5 to determine TD_{PWM_B}, TD_{PWM_C} and TD_{PWM_D} for the phase circuitry 206B, 206C, 206D, respectively.

The example phase circuits 206 are configured to increase the current of the output signal (thereby increasing the voltage of the CSP signals 216) whenever the corresponding PWM signals 214 are at a logical ‘1’. While the controller circuitry 202 establishes a minimum pulse width in the PWM signals 214, a first pulse sent in example PWM signal 214A may vary in width (i.e., vary in how long the signal is at a logical ‘1’) from a second pulse sent in the example PWM signal 214B. Because of varying pulse widths in the example PWM signals 214, some of the CSP signals 216 may cross the voltage threshold after one pulse, while other phase circuits 206 may require two consecutive pulses in the corresponding PWM signal before the corresponding CSP signal crosses the voltage threshold. Accordingly, the counter value of a CSP signal crossing the voltage threshold after one pulse will be significantly different from the counter value of a CSP signal crossing the voltage threshold after two pulses.

Advantageously, the pulse calibrator circuitry 204 monitors whether a given CSP signal 216A requires one or two pulses in the corresponding PWM signal 214A and adjusts TD_{TOTAL_A} value accordingly. For example, if the CSP signal 216A requires two pulses to cross the voltage threshold, the pulse calibrator circuitry 204 may first divide the counter value by two before subtracting pre-determined values corresponding to TD_{CON_PWM}, TD_{PHASE}, and TD_{CON_CSP} as described above. In such an example, the first division by two accounts for the fact that two pulses were sent. After subtracting the pre-determined values, the example pulse calibrator circuitry 204 performs a second division by two to remove TD_{CSP_A} as described above. As a result, the example pulse calibrator circuitry 204 ensures TD_{PWM} is independent of the width of a pulse. Rather, TD_{PWM} is only representative of the time between when an output terminal of the controller circuitry 202 increases in voltage to send a pulse and when said pulse arrives at an input terminal of the corresponding phase circuit.

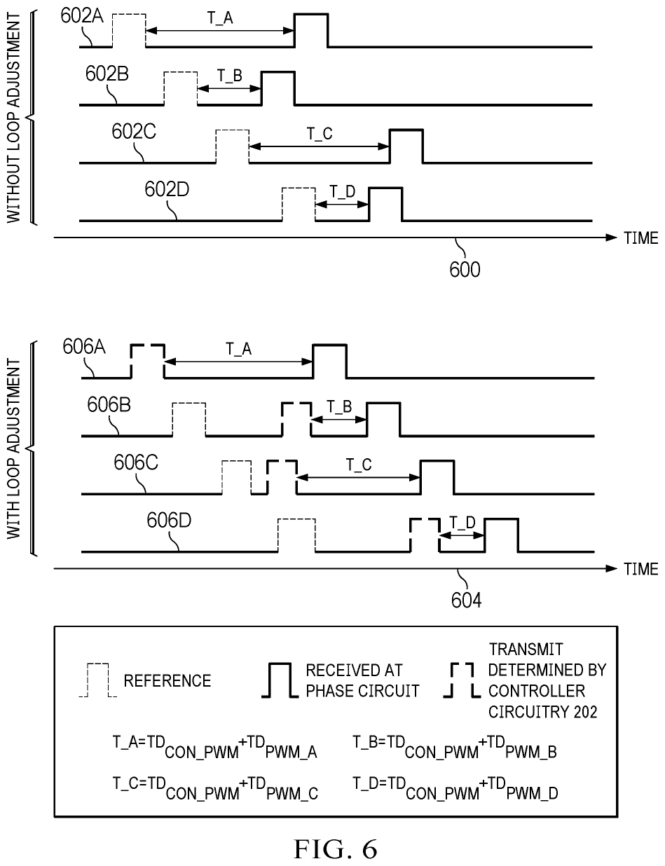

FIG. 6 is a first timing diagram of operations performed by previous solutions and a third example timing diagram of operations performed by the voltage regulator circuitry of FIG. 1. A timeline 600 of operations is labelled “without loop adjustment” in FIG. 6 and includes signals 602A, 602B, 602C, 602D. An example timeline 604 of operations performed by the example voltage regulator circuitry of FIG. 1 is labelled “with loop adjustment” and includes example signals 606A, 606B, 606C, 606D.

The timeline 600 shows a set of pulses that may be sent by a controller of a previous multi-phase buck regulator. The previous controller transmits pulses to four phase circuits in an interleaved manner (i.e., transmits the pulses sequentially with an equal amount of time between each pulse), as shown by the dotted and dashed reference pulses in signals 602A. 602B, 602C, 602D. However, if the previous controller is implemented in an environment where the phase circuits are a non-uniform distance from the controller, such as the PCB of FIG. 3, the previous controller would incorrectly assume that TD_{PWM_A}=TD_{PWM_B}=TD_{PWM_C}=TD_{PWM_D}. As a result, the pulses transmitted by the previous controller would not arrive at the phase circuits in an interleaved manner, as shown by the solid line pulses of signals 602A, 602B, 602C, 602D. Failure to deliver pulses to phase circuits in an interleaved manner may increase the ripple voltage exhibited in the VOUT signal transmitted to the load. In addition to the VOUT signal being poorer quality, an increased ripple voltage may result in damage to the electrical components of the multi-phase buck regulator and/or unexpected behavior from the load.

In contrast, the example pulse calibrator circuitry 204 performs loop adjustment to the pulses in accordance with the teachings of this disclosure and shown on the example timeline 604. Loop adjustment refers to the operations performed by the pulse calibrator circuitry 204 to solve a system of equations given by equations (1), (2), (3), and (4):

$$\begin{matrix}( 1 ) & {T}_{SEND\_A} + {TD}_{CON\_PWM} + {TD}_{PWM\_A} = {T}_{ARRIVE\_A} \\ ( 2 ) & {T}_{SEND\_B} + {TD}_{CON\_PWM} + {TD}_{PWM\_B} = {T}_{ARRIVE\_A} + {TD}_{interleave} \\ ( 3 ) & {T}_{SEND\_C} + {TD}_{CON\_PWM} + {TD}_{PWM\_C} = {T}_{ARRIVE\_A} + 2 ( {TD}_{interleave} ) \\ ( 4 ) & {T}_{SEND\_D} + {TD}_{CON\_PWM} + {TD}_{PWM\_D} = {T}_{ARRIVE\_A} + 3 ( {TD}_{interleave} )\end{matrix}$$

In equation (1), T_{SEND_A} refers to the point in time when the example controller circuitry 202 determines to transmit a pulse in the PWM signal 214A. T_{SEND_A} is illustrated in FIG. 6 as the rising edge of the dashed line pulse in the example signal 602A. Similarly, in equation (2), T_{SEND_B} refers to when the example controller circuitry 202 determines to transmit a pulse in the PWM signal 214B and is represented by the rising edge of the dashed line pulse in the example signal 602B, etc. In the foregoing system of equations, TD_{CON_PWM} refers to the internal delays between when the controller circuitry 202 determines to send a pulse and when the output terminal of the controller increases in voltage, as described above in connection with FIG. 4. TD_{PWM_A}, TD_{PWM_B}, TD_{PWM_C}, and TD_{PWM_D} are different values that refer the time required for a pulse to travel from the controller circuitry 202 to a phase circuit as described above in connection with FIGS. 4 and 5. In some examples, the pulse calibrator circuitry 204 determines TD_{PWM_A}, TD_{PWM_B}, TD_{PWM_C}, and TD_{PWM_D} with a set of pulses (e.g., zeroth pulses) that are transmitted before the pulse calibrator circuitry 204 solves the foregoing system of equations. T_{ARRIVE_A} represents when the pulse of the PWM signal 214A arrives at the phase circuitry 206A and is illustrated in FIG. 6 as the rising edge of the solid line pulse in signal 602A. Finally, TDᵢₙₜₑᵣₗₑₐᵥₑ represents the amount of time between when an initial pulse arrives at a first phase circuit and a subsequent pulse arrives at a second phase circuit.

The example pulse calibrator circuitry 204 can solve the foregoing system of equations because T_{ARRIVE_A}, TDᵢₙₜₑᵣₗₑₐᵥₑ, TD_{CON_PWM}, TD_{PWM_A}, TD_{PWM_B}, TD_{PWM_C}, and TD_{PWM_D} are known values. For example, T_{ARRIVE_A} may be determined from clock circuitry. TDᵢₙₜₑᵣₗₑₐᵥₑ and TD_{CON_PWM} are pre-determined values stored in memory. Furthermore, the example pulse calibrator circuitry 204 determines TD_{PWM_A}, TD_{PWM_B}, TD_{PWM_C}, and TD_{PWM_D} by adjusting a counter value as described in connection with FIG. 5. Therefore, when the pulse calibrator circuitry 204 receives instructions to transmit a series of pulses to the phase circuits 206, the system of equations has four unknown variables and four equations. As a result, the example pulse calibrator circuitry 204 solves for T_{SEND_A}, T_{SEND_B}, T_{SEND_C}, and T_{SEND_D} and determines when to send pulses in the PWM signals 214 accordingly.

By performing the loop adjustment, the example pulse calibrator circuitry 204 determines a wait period for one or more pulses. For example, the signal 602B shows that a previous controller would have determined to send a pulse in the PWM signal 214B after TDᵢₙₜₑᵣₗₑₐᵥₑ has passed from determining to send a pulse in the PWM signal 214A. In contrast, the example signal 606B shows that the example pulse calibrator circuitry 204 waits to transmit a pulse for an additional period past the point in time when the previous controller circuit would have. Similarly, the example pulse calibrator circuitry 204 waits for additional periods to transmit pulses in the PWM signals 214C. 214D when compared to the previous solution.

The additional wait periods of the example pulse calibrator circuitry 204 account for the fact that TD_{PWM_A}≠TD_{PWM_B}≠TD_{PWM_C}≠TD_{PWM_D} due to non-uniform distance between the phase circuits 206 and the controller circuitry 202. Advantageously, the example pulse calibrator circuitry 204 enables pulses to arrive in an interleaved fashion to phase circuits 206 that are not equidistant from the controller circuitry 202. As a result, the example controller circuitry 202 supports the design of multi-phase buck regulator circuits with more phase circuits and/or more complex PCBs than previous solutions.

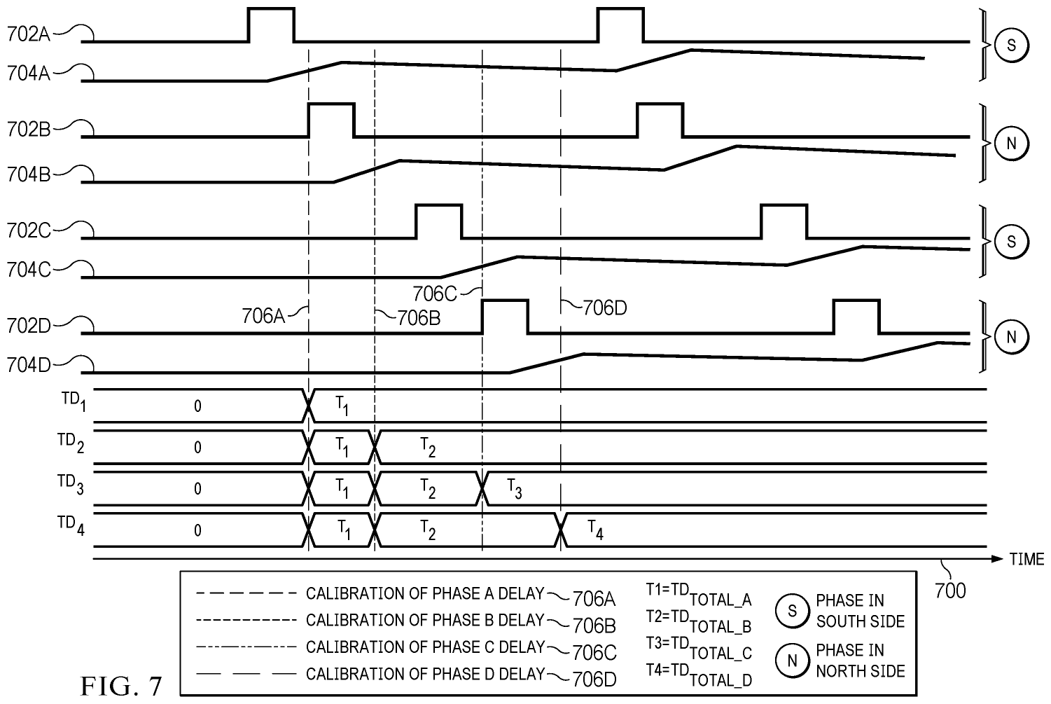

FIG. 7 is a fourth example timeline of operations performed by the voltage regulator circuitry of FIG. 1. FIG. 7 includes an example timeline 700, which contains example signals 702A, 704A, 702B, 704B, 702C, 704C, 702D, 704D, and example calibration times 706A, 706B, 706C, 706D. FIG. 7 also includes a south side marker or a north side marker for each pair of signals (e.g., signals 702A and 704A are one pair, signals 702B and 704B are another pair, etc.).

In FIG. 7, a phase circuit's location within a PCB is noted by either the south side marker or the north side marker and is assigned relative to the position of the controller circuitry 202. For example, in the example PCB view 300 of FIG. 3, phase circuit regions 302, 304, 306 may be considered in the north side of the PCB because their y coordinates are greater than the controller region 301. Similarly, example phase circuit regions 308, 310, 312 may be considered in the south side of the PCB because their y coordinates are less than the controller region 301. In FIG. 7, the example phase circuitry 206A, 206C are located in the south side of a hypothetical PCB, while example phase circuitry 206B, 206D are located in the north side of the hypothetical PCB.

Like the example signal 404, the example signal 702A describes the voltage of an output terminal of the controller circuitry 202 corresponding to the PWM signal 214A. Similarly, the example signal 702B shows the voltage of an output terminal of the controller circuitry 202 corresponding to the PWM signal 214B, etc.

Like the example signal 410, the example signal 704A describes the voltage of an input terminal of the controller circuitry 202 corresponding to the CSP signal 216A. Similarly, the example signal 704B shows the voltage of an input terminal of the controller circuitry 202 corresponding to the CSP signal 216B, etc.

In some examples, the example multi-phase buck regulator circuitry may enter a sleep state where all phase circuits 206 are disabled and no PWM signals 214 are sent. As described above, in many examples, the multi-phase buck regulator circuitry 108 is required to send pulses that arrive in an interleaved fashion to the phase circuits 206. However, when awakening from an example sleep state, or when being powered on from a previous off state, the example pulse calibrator circuitry 204 has not yet determined any of TD_{PWM_A}, TD_{PWM_B}, TD_{PWM_C} and TD_{PWM_D}.

Advantageously, the example pulse calibrator circuitry 204 uses an approximation algorithm to determine what values to use for TD_{PWM_A}, TD_{PWM_B}, TD_{PWM_C} and TD_{PWM_D} the first time pulses are sent after a powering on or awakening from a sleep state. In particular, the example pulse calibrator circuitry 204 takes an average of all calibrated phases within a given side of a PCB. For example, suppose the hypothetical PCB of FIG. 7 has six total phase circuits. Suppose the six phase circuits include the example phase circuits 206 located in both the south and north regions as described above, a phase circuit ‘E’ located in the south region, and a phase circuit ‘F’ located in the north region. When the pulse calibrator circuitry 204 first determines when to send a pulse to phase circuit ‘F’, it approximates the delay required for the pulse to reach phase circuit ‘F’ as:

$${TD}_{PWM\_F} = \frac{{TD}_{PWM\_B} + {TD}_{PWM\_D}}{2}$$

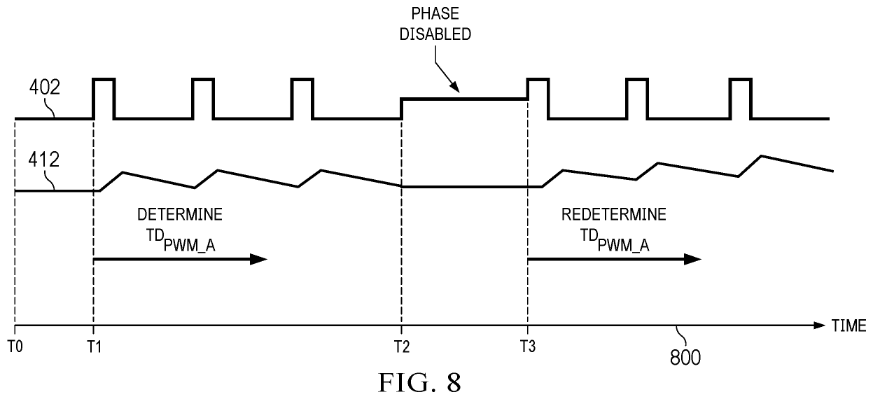

FIG. 8 is a fifth example timing diagram of operations performed by the multi-phase buck regulator circuitry of FIG. 1. The example timeline 800 of FIG. 8 includes the example signal 402 and the example signal 412. The example timeline also includes timestamps T0, T1. T2, and T3, which are independent of and unrelated to any timestamps from FIGS. 1-7.

The example timeline 800 shows operations performed by the example pulse calibrator circuitry 204 with respect to example phase circuitry 206A. In the illustrative example of FIG. 8, the multi-phase buck regulator circuitry 108 is powered on at TO. As a result, the example pulse calibrator circuitry 204 begins to determine TD_{PWM_A} (e.g., initializes a counter as described in connection with FIG. 5) the first time a pulse is sent at T1.

The example pulse calibrator circuitry 204 only needs to determine TD_{PWM_A} once per duration of time when the example phase circuitry 206A is enabled. However, the example controller circuitry 202 may disable and re-enable one or more phases at any time to accommodate the changing power demands of the load. For example, in FIG. 8, the controller circuitry 202 disables the phase circuitry 206A at T2 (as indicated by the intermediate voltage in the signal 402) and re-enables the phase circuitry 206A at T3. Any amount of time may exist between T2 and T3.

Advantageously, the example pulse calibrator circuitry 204 redetermines TD_{PWM_A} at T3, and more generally, redetermines a TD_{PWM} value any time one of the phase circuits 206 is re-enabled. As a result, that example pulse calibrator circuitry 204 ensures that any change in a TD_{PWM} value that may occur due to factors such as temperature, voltage, aging etc. over the lifetime of the multi-phase buck regulator circuitry 108 is taken into consideration.

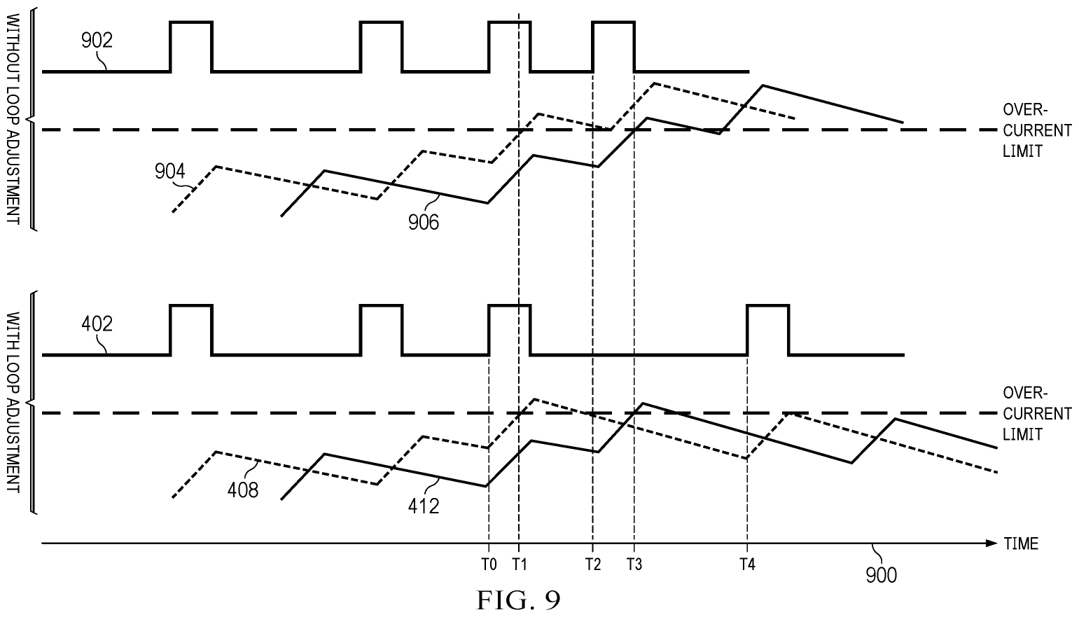

FIG. 9 is a sixth example timing diagram of operations performed by the multi-phase buck regulator circuitry of FIG. 1. The example timeline 900 of FIG. 9 includes signals 902, 904, and 906, which are labelled as “without loop adjustment”. The example timeline 900 also includes the example signals 402, 408, and 412, which are labelled as “with loop adjustment”. The example timeline 900 also includes example timestamps T1, T2, T3, and T4 which are independent of and unrelated to any timestamps from FIGS. 1-8.

The signals 902, 904, 906 correspond to a controller of a previous solution to implement a multi-phase buck regulator circuit. The signal 902 represents when the previous controller determines to send a pulse to a particular phase circuit of the previous solution. The signal 904 is a voltage representative of the current flowing through said previous solution phase circuit, when measured at the previous solution phase circuit. The signal 906 is a voltage representative of the current of the previous solution phase circuit when measured at the previous controller. That is, the signal 906 is a time-shifted copy of the signal 904. The amount that the signal 906 lags behind the signal 904 is determined by the length of the interconnect that couples the previous controller to the previous solution phase circuit.

The example signals 402, 408, 412 represent signals within the example multi-phase buck regulator circuitry 108 as described in accordance with the teachings of this disclosure. As described in FIG. 4, the example signal 402 represents when the example pulse calibrator circuitry 204 determines to send a pulse to the example phase circuitry 206A. The example signal 408 is a voltage representative of the current flowing through example phase circuitry 206A, as measured at the example phase circuitry 206A. The example signal is a voltage representative of the current flowing through example phase circuitry 206A when measured at the example controller circuitry 202.

Before determining whether to transmit an additional pulse to the previous solution phase circuit, the previous controller may sample the signal 906 to confirm the voltage is less than a maximum threshold voltage. A controller may implement the maximum threshold voltage to implement a corresponding maximum current limit to the phase circuit, referred to in FIG. 9 as an over-current limit.

If the previous controller is implemented in an environment where the phase circuits are a non-uniform distance from the controller, such as the PCB of FIG. 3, the non-uniformity may cause the previous controller to sample the signal 906 incorrectly because the previous controller cannot accurately measure the time shift between signals 904 and 906.

As an example, in FIG. 9, a peak demand for power from a hypothetical load causes both the previous controller and the example pulse calibrator circuitry 204 to intentionally allow a phase circuit to temporarily exceed the over-current limit. The signal 904 and the example signal 408 show that the current flowing through the previous solution phase circuit and the example phase circuitry 206A both cross the over-current limit at T1. Based on incorrect information regarding the time-shift between signals 904 and 906, the previous controller determines whether to transmit an additional pulse somewhere between T1 and T2. Between T1 and T2, the signal 906 shows that the current of the phase circuit, when measured at the previous controller, is still below the over-current limit. As a result, the signal 902 shows the previous controller determines an additional pulse should be transmitted at T2. However, the signal 904 shows that the current of the phase circuit is above the over-current limit at T2. By sending an unneeded pulse at T2, the previous controller causes the current flowing through the phase circuit to rise further above the current limit than was necessary, thereby potentially damaging the circuit.

Advantageously, the example pulse calibrator circuitry 204 avoids sending additional pulses by implementing loop adjustment in accordance with the teachings of the disclosure. In some examples, a peak demand for power from the load may cause the example phase circuitry 206A to intentionally allow the phase circuitry 206A to temporarily exceed the current limit. For example, the signal 408 shows that the current flowing through the phase circuitry 206A crosses the over-current limit at T1. However, rather than determining whether to transmit an additional pulse between T1 and T2 as the previous controller does, the example pulse calibrator circuitry 204 waits to decide until the current of the phase circuitry 206A is observed to have fallen below over-current limit.

The example signal 412 shows that the example pulse calibrator circuitry 204 first samples and observes that the phase circuitry 206A has passed the over-current limit at T3. Therefore, after transmitting a pulse at TO, the example pulse calibrator circuitry 204 waits until at least T3 to determine whether to transmit an additional pulse.

The example pulse calibrator circuitry 204 knows how much the current of phase circuitry 206A will increase from a particular pulse (i.e., how much signals 408 and 412 will increase from a particular pulse). The example pulse calibrator circuitry 204 can also approximate the current presently flowing through the phase circuitry 206A the values of TD_{CSP_A} and TD_{CON_CSP} (which collectively describe how much the example signal 412 lags behind the example signal 408) are either known or determinable. The example pulse calibrator circuitry 204 uses the foregoing information to ultimately wait until T4 before determining to transmit an additional pulse. As a result, the total amount of time in which the phase circuitry 206A exceeds the over-current limit is minimized.

While an example manner of implementing the multi-phase buck regulator circuitry 108 of FIG. 1 is illustrated in FIG. 2, one or more of the elements, processes, and/or devices illustrated in FIG. 2 may be combined, divided, re-arranged, omitted, eliminated, and/or implemented in any other way. Further, the example pulse calibrator circuitry 204, and/or, more generally, the example controller circuitry 202 of FIG. 2, may be implemented by hardware alone or by hardware in combination with software and/or firmware. Thus, for example, any of the example pulse calibrator circuitry 204, and/or, more generally, the example controller circuitry 202 of FIG. 2, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example multi-phase buck regulator circuitry 108 of FIG. 1 may include one or more elements, processes, and/or devices in addition to, or instead of, those illustrated in FIG. 2, and/or may include more than one of any or all of the illustrated elements, processes and devices.

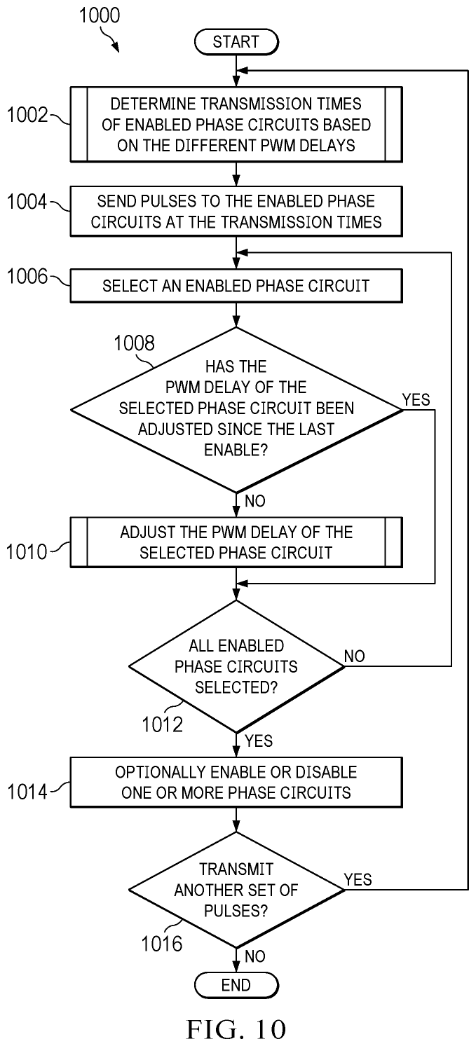

A flowchart representative of example machine-readable instructions, which may be executed to configure processor circuitry to implement the multi-phase buck regulator circuitry 108 of FIG. 1, is shown in FIGS. 10-12. The machine-readable instructions may be one or more executable programs or portion(s) of an executable program for execution by processor circuitry, such as the processor circuitry 1312 shown in the example processor platform 1300 discussed below in connection with FIGS. 10-12. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 10-12, many other methods of implementing the example multi-phase buck regulator circuitry 108 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine-readable instructions as described herein may be stored as data or a data structure (e.g., as portions of instructions, code, representations of code, etc.) that may be utilized to create, manufacture, and/or produce machine executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable media, as used herein, may include machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 10-12 may be implemented using executable instructions (e.g., computer and/or machine-readable instructions) stored on one or more non-transitory computer and/or machine-readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine-readable medium, and non-transitory machine-readable storage medium are expressly defined to include any type of computer readable storage device and/or storage disk and to exclude propagating signals and to exclude transmission media. As used herein, the terms “computer readable storage device” and “machine-readable storage device” are defined to include any physical (mechanical and/or electrical) structure to store information, but to exclude propagating signals and to exclude transmission media. Examples of computer readable storage devices and machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B. (5) A with C. (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A. (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A. (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A. (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 10 is a flowchart representative of an example process that may be performed using machine-readable instructions that can be executed and/or hardware configured to implement the controller circuitry 202 of FIG. 2, and/or, more generally, the multi-phase buck regulator circuitry 108 of FIG. 1.

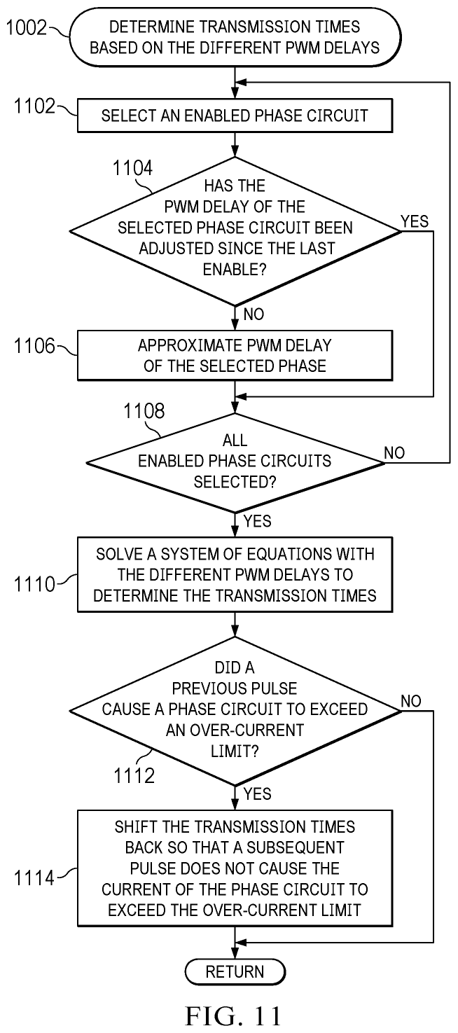

The example machine-readable instructions 1000 begin when the example pulse calibrator circuitry 204 determines the transmission times (i.e., one or more of T_{SEND_A}. T_{SEND_B}, T_{SEND_C}, and T_{SEND_D}) of enabled phase circuits based on the different PWM delays (i.e., one or more of TD_{PWM_A}, TD_{PWM_B}, TD_{PWM_C} and TD_{PWM_D}). (Block 1002). Block 1002 is discussed further in connection with FIG. 11.

The example pulse calibrator circuitry 204 sends the pulses to the enabled phase circuits at the transmission times. (Block 1004). For example, the pulse calibrator circuitry 204 may transmit a pulse in the PWM signal 214A at T_{SEND_A}, transmit a pulse in the PWM signal 214B at T_{SEND_B}, etc., depending on which phases are enabled at the time block 1004 is implemented.

The example pulse calibrator circuitry 204 selects an enabled phase circuit. (Block 1006). The example pulse calibrator circuitry 204 then determines whether the PWM delay of the selected phase circuit has been adjusted since the last time the phase circuit was enabled. (Block 1008). To make the determination of block 1008, the example pulse calibrator circuitry 204 may raise a flag in memory each time a PWM delay is adjusted and reset the flag each time the controller circuitry 202 subsequently disables the corresponding phase circuit.

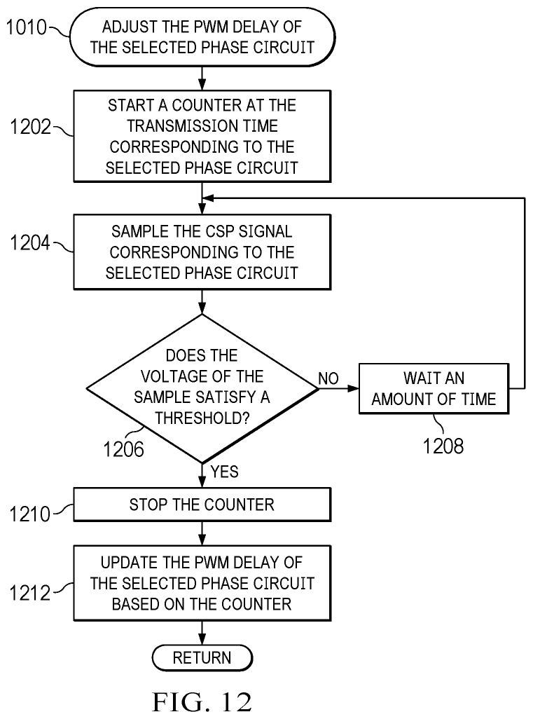

If the PWM delay of the selected phase circuit has been adjusted since the last time the phase circuit was enabled (Block 1008: Yes), control proceeds directly to block 1012. Alternatively, if the PWM delay of the selected phase circuit has not been adjusted since the last time the phase circuit was enabled (Block 1008: No), the example pulse calibrator circuitry 204 adjusts the PWM delay of the selected phase circuit. Block 1010. Block 1010 is discussed further in connection with FIG. 12.

The example pulse calibrator circuitry 204 determines whether all enabled phase circuits have been selected in the current iteration of the flowchart of FIG. 10. (Block 1012). If all enabled phase circuits have not been selected (Block 1012: No), control returns to block 1006 where the example pulse calibrator circuitry 204 selects a phase circuit that was previously unselected in the current iteration of the flowchart of FIG. 10.

If all enabled phase circuits have been selected (Block 1012: Yes), the example controller circuitry 202 optionally enables or disables one or more of the example phase circuits 206. (Block 1014). The example controller circuitry 202 may enable or disable a phase circuit in response to a change in the power demands of the load circuit.

The example controller circuitry 202 determines whether to transmit another set of pulses. (Block 1016). In some examples, the example controller circuitry 202 continually transmits additional pulses in any phase circuit that remains enabled. If the example controller circuitry 202 determines to transmit additional pulses (Block 1016: Yes), control returns to block 1002 where the example pulse calibrator circuitry determines one or more of T_{SEND_A}. T_{SEND_B}, T_{SEND_C}, and T_{SEND_D} for the next set of pulses. If the example controller circuitry 202 determines not to transmit additional pulses (Block 1016: No), the example machine-readable instructions 1000 end.

The example flowchart of FIG. 10 shows the PWM delay of the selected phase circuits being adjusted sequentially (as shown by the loop of blocks 1006-1012) for simplicity. However, as discussed in connection with FIG. 5 and will be discussed again in FIG. 11, the adjustment of a PWM delay is time sensitive set of operations that depends on when the pulse is transmitted in the PWM signal 214. Therefore, instead of implementing blocks 1006-1012 in some examples, the example pulse calibrator circuitry 204 implements multiple instances of block 1010 in parallel for each of the selected phase circuits. In such examples, control flows from block 1006 directly to block 1010. Control then flows to block 1014 once all PWM delays have been determined in parallel at block 1010.

FIG. 11 is a flowchart representative of an example process that may be performed using machine-readable instructions that can be executed and/or hardware configured to determine transmission times as described in connection with FIG. 10. In particular, the flowchart of FIG. 11 describes how the example machine-readable instructions 1000 implement block 1002 of FIG. 10.

Execution of block 1002 begins when the example pulse calibrator circuitry 204 selects an enabled phase circuit. (Block 1102). The example pulse calibrator circuitry 204 then determines whether the PWM delay of the selected phase circuit has been adjusted since the last time the phase circuit was enabled. (Block 1104). To make the determination of block 1008, the example pulse calibrator circuitry 204 may raise a flag in memory each time a PWM delay is adjusted and reset the flag each time the controller circuitry 202 subsequently disables the corresponding phase circuit.

If the PWM delay of the selected phase circuit has been adjusted since the last time the phase circuit was enabled (Block 1104: Yes), control proceeds directly to block 1108. Alternatively, if the PWM delay of the selected phase circuit has not been adjusted since the last time the phase circuit was enabled (Block 1104: No), the example pulse calibrator circuitry 204 approximates the PWM delay of the selected phase. (Block 1106). For example, the pulse calibrator circuitry 204 approximates the PWM delay by taking an average of PWM delays that 1) have been updated since their last enable and 2) are located in the same region of the PCB as the selected phase circuit, as described above in connection with FIG. 7.

The example pulse calibrator circuitry 204 determines whether all enabled phase circuits have been selected in the current iteration of the flowchart of FIG. 11. (Block 1108). If all enabled phase circuits have not been selected (Block 1108: No), control returns to block 1102 where the example pulse calibrator circuitry 204 selects a phase circuit that was previously unselected in the current iteration of the flowchart of FIG. 11.

If all enabled phase circuits have been selected (Block 1108: Yes), the example pulse calibrator circuitry 204 solves a system of equations with the different PWM delays to determine the transmission times. (Block 1110). In particular, the example pulse calibrator circuitry 204 solves for T_{SEND_A}, T_{SEND_B}, T_{SEND_C}, and T_{SEND_D} in equations (1), (2), (3), and (4) as described above.

The example pulse calibrator circuitry 204 determines whether the current flowing through a phase circuit has exceeded an over-current limit due to a previous pulse. (Block 1112). The example pulse calibrator circuitry 204 may make the determination of block 1112 based on the voltage of the CSP signals 216 at the time previous pulses were transmitted and the amount of time that has passed since each previous pulse was transmitted.

If the example pulse calibrator circuitry 204 determines a previous pulse has caused a phase circuit to exceed an over-current limit (Block 1112: Yes), the example pulse calibrator circuitry 204 shifts for T_{SEND_A}, T_{SEND_B}, T_{SEND_C}, and T_{SEND_D} back so that a subsequent pulse does not cause the current of the phase circuit to exceed the over-current limit. (Block 1114). As described above in connection with FIG. 9, the example pulse calibrator circuitry 204 determines the amount to shift the transmission times based on an expected amperage increase of a phase circuit caused by a given pulse. Alternatively, if the example pulse calibrator circuitry 204 determines a previous pulse has not caused a phase circuit to exceed an over-current limit (Block 1112: No), control returns to block 1004.

To minimize ripple voltage and provide a VOUT signal to the load circuit that satisfies an expected performance, pulses in the example PWM signals 214 arrive to the example phase circuits 206 in an interleaved fashion. As used above and herein, pulses arriving in an interleaved fashion means that a first pulse arrives at phase circuitry 206A before a second pulse arrives at phase circuitry 206B, the second pulse arrives at phase circuitry 206B before a third pulse arrives at phase circuitry 206C, etc. The arrival of pulses in an interleaved fashion also means that the time between when the first pulse and second pulse arrive is equal to the time between when the second pulse and the third pulse arrive (i.e., TDᵢₙₜₑᵣₗₑₐᵥₑ is constant between any two subsequent pulses). Finally, the arrival of pulses in an interleaved fashion means that a fourth pulse arrives at the example phase circuitry 206D arrives before a fifth pulse arrives at the example phase circuitry 206A. Advantageously, to ensure the pulses arrive in an interleaved fashion according to the foregoing description, the example pulse calibrator circuitry 204 solves the system of equations at block 1110 that accounts for the non-uniform delay between the controller and the phase circuits 206. Furthermore, when necessary, the example pulse calibrator circuitry 204 adjusts the transmission times at block 1114 to minimize the time a phase circuit exceeds an over-current limit and prevent damages to the multi-phase buck regulator circuitry 108.

FIG. 12 is a flowchart representative of an example process that may be performed using machine-readable instructions that can be executed and/or hardware configured to adjust PWM delay times. In particular, the example flowchart of FIG. 12 describes how the example pulse calibrator circuitry 204 implements block 1010 of FIG. 10.

Execution of block 1010 begins when the example pulse calibrator circuitry 204 starts a counter at the transmission time corresponding to the selected phase circuit. (Block 1202). For example, if the selected phase circuit of block 1006 is the phase circuitry 206A, the counter of block 1202 starts at T_{SEND_A}. Additionally or alternatively, if the selected phase circuit of block 1006 is the phase circuitry 206B, the counter of block 1202 starts at T_{SEND_B}. Once started, the example pulse calibrator circuitry 204 increments the counter at a regular interval (e.g., once per clock cycle) until the counter is stopped.

The example pulse calibrator circuitry 204 samples one of the CSP signals 216 corresponding to the selected phase circuit. (Block 1204). A sample of one of the CSP signals 216 is a voltage that is proportional to the current flowing through the corresponding one the phase circuits 206.

The example pulse calibrator circuitry 204 identifies whether the voltage of the sample satisfies a threshold. (Block 1206). To identify whether the threshold is satisfied, the example pulse calibrator circuitry 204 determines when the sampled voltage is greater or equal to a threshold voltage.

If the sampled voltage does not satisfy the threshold (Block 1206: No), the example pulse calibrator circuitry 204 waits an amount of time. (Block 1208). The counter of block 1202 continues to increase during the wait period of block 1208. After the wait period, control returns to block 1204 where the example pulse calibrator circuitry 204 takes another sample of the CSP signal 216 corresponding to the selected phase circuit.

Alternatively, if the samples voltage does satisfy the threshold (Block 1206: Yes), the example pulse calibrator circuitry 204 stops the counter. (Block 1210). The example pulse calibrator circuitry 204 then updates the PWM delay of the selected phase circuit based on the counter. (Block 1212). For example, as described above in connection with FIG. 5, the pulse calibrator circuitry 204 subtracts pre-determined values from the counter for TD_{CON_PWM}. TD_{PHASE}, and TD_{CON_CSP}. The example pulse calibrator circuitry 204 also makes either one or two separate divisions by two depending on the number of pulses required for the phase circuit to cross the threshold. As described above in connection with FIG. 5, the adjusted counter value represents TD_{PWM} and, in the context of block 1212, is an updated version of TD_{PWM}.

In the example flowchart of FIG. 10, control returns to example block 1012 after block 1212. In other examples where the pulse calibrator circuitry 204 implements multiple instances of block 1010 in parallel for each enabled phase circuit, control returns to block 1014 after each parallel instance of block 1212 is implemented.

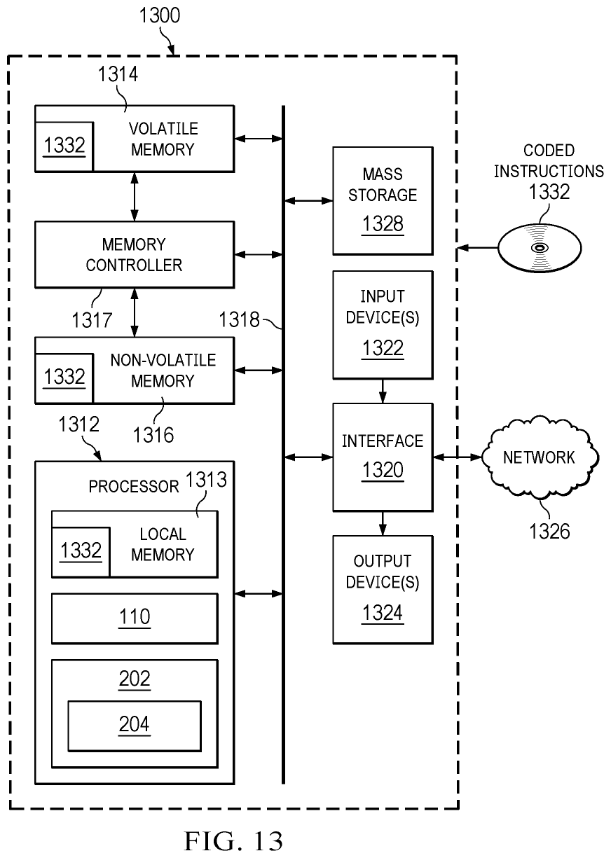

FIG. 13 is a block diagram of an example processor platform 1300 structured to execute and/or instantiate the machine-readable instructions and/or the operations of FIGS. 10-12 to implement the multi-phase buck regulator circuitry 108 of FIG. 1. The processor platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1300 of the illustrated example includes processor circuitry 1312. The processor circuitry 1312 of the illustrated example is hardware. For example, the processor circuitry 1312 can be implemented by one or more integrated circuits, logic circuits, FPGAs, microprocessors, CPUs, GPUs, DSPs, and/or microcontrollers from any desired family or manufacturer. The processor circuitry 1312 may be implemented by one or more semiconductor based (e.g., silicon based) devices. In this example, the processor circuitry 1312 implements the processor circuitry 110, the controller circuitry 202, and the pulse calibrator circuitry 204.

The processor circuitry 1312 of the illustrated example includes a local memory 1313 (e.g., a cache, registers, etc.). The processor circuitry 1312 of the illustrated example is in communication with a main memory including a volatile memory 1314 and a non-volatile memory 1316 by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317.

The processor platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user to enter data and/or commands into the processor circuitry 1312. The input device(s) 1322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1300 of the illustrated example also includes one or more mass storage devices 1328 to store software and/or data. Examples of such mass storage devices 1328 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine-readable instructions 1332, which may be implemented by the machine-readable instructions of FIGS. 10-12, may be stored in the mass storage device 1328, in the volatile memory 1314, in the non-volatile memory 1316, and/or on a removable non-transitory computer readable storage medium such as a CD or DVD.

In this description, the term “and/or” (when used in a form such as A, B and/or C) refers to any combination or subset of A, B, C, such as: (a) A alone; (b) B alone; (c) C alone; (d) A with B; (c) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

Example methods, apparatus and articles of manufacture described herein improve the efficiency of a compute device by enabling example multi-phase buck regulator circuitry 108 in which the example phase circuits 206 both 1) receive pulses from controller circuitry 202 in an interleaved fashion as described above and 2) are located a non-uniform distance from the controller circuitry 202. As a result, the example multi-phase buck regulator circuitry 108 avoids ripple voltage in a VOUT signal provided to a load circuit, satisfies an expected performance, can be implemented in smaller and/or more complex PCB designs than previous solutions, and can be implemented in PCB designs with more phase circuits than previous solutions.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Numerical identifiers such as “first”, “second”, “third”, etc. are used merely to distinguish between elements of substantially the same type in terms of structure and/or function. These identifiers, as used in the detailed description, do not necessarily align with those used in the claims.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Unless otherwise stated, “about,” “approximately,” or “substantially” preceding a value means+/−10 percent of the stated value, or, if the value is zero, a reasonable range of values around zero.

Modifications are possible in the described embodiments, and other embodiments are possible, within the scope of the claims.

What is claimed is:

1. An apparatus comprising:
phase circuits including first phase circuitry, second phase circuitry, and third phase circuitry, the phase circuits implemented on a printed circuit board with controller circuitry, the phase circuits located a non-uniform distance from the controller circuitry, each of the phase circuits configured to:
receive an input voltage from a voltage source; and
provide, based on the input voltage and a pulse, an output signal; and
the controller circuitry configured to:
determine a first delay corresponding to an amount of time for a first pulse to reach the first phase circuitry;
determine a second delay corresponding to an amount of time for a second pulse to reach the second phase circuitry;
determine a third delay corresponding to an amount of time for a third pulse to reach the third phase circuitry; and
transmit, based on the first delay, the second delay, and the third delay, the first pulse to the first phase circuitry, the second pulse to the second phase circuitry, and a third pulse to the third phase circuitry such that a first time period between the first pulse and the second pulse is equal to a second time period between the second pulse and the third pulse, wherein:
the first time period is an amount of time between when the first pulse arrives at the first phase circuitry and when the second pulse arrives at the second phase circuitry; and
the second time period is an amount of time between when the second pulse arrives at the second phase circuitry and when the third pulse arrives at the third phase circuitry.

2. The apparatus of claim 1, wherein the non-uniform distance between the phase circuits and the controller circuitry causes one or more of the first delay, the second delay, and the third delay to be a different value from the other delays.

3. The apparatus of claim 1, wherein the controller circuitry is configured to:
transmit a zeroth pulse to the first phase circuitry, the zeroth pulse sent before the first pulse;
identify a change in a current sensing pin (CSP) signal from the first phase circuitry, the change proportional to an amperage increase in the output signal caused by the zeroth pulse; and
determine the first delay based on a time difference between the providing of the zeroth pulse and the identification of the change.

4. The apparatus of claim 3, wherein the controller circuitry is configured to:
identify the CSP signal corresponding to the first pulse has exceeded an over-current limit;
wait until the CSP signal has fallen below the over-current limit; and
determine, after waiting, when to transmit a fourth pulse to the first phase circuitry based on the first delay, the second delay, and the third delay.

5. The apparatus of claim 3, wherein the change is a first change, wherein to determine the second delay, the controller circuitry is configured to:
determine the first delay;
approximate the second delay as equal to the first delay when transmitting the first pulse, the second pulse, and the third pulse;
identify a second change in a CSP signal from the second phase circuitry, the second change proportional to an increase in the current of an output signal caused by the second pulse;
update the second delay based on a time difference between the providing of the second pulse and the identification of the second change; and
use the updated second delay when determining when to transmit additional pulses.

6. The apparatus of claim 5, wherein the first phase circuitry and the second phase circuitry are located on a same region of the printed circuit board relative to a location of the controller circuitry.

7. The apparatus of claim 1, wherein the controller circuitry is configured to:
disable, after transmitting the second pulse, the second phase circuitry;
re-enable, an amount of time after disabling, the second phase circuitry;
transmit, based on the first delay, the second delay, and the third delay, a fourth pulse to the first phase circuitry, a fifth pulse to the second phase circuitry, and a sixth pulse to the third phase circuitry;
identify a change in a current sensing pin (CSP) signal from the second phase circuitry, the change proportional to an increase in the current of an output signal caused by the fifth pulse; and
update the second delay based on a time difference between the providing of the fifth pulse and the identification of the change; and
use the updated second delay when determining when to transmit additional pulses.

8. A non-transitory machine-readable storage medium comprising instructions that, when executed, configure processor circuitry to at least:
determine a first delay corresponding to an amount of time for a first pulse to reach first phase circuitry;
determine a second delay corresponding to an amount of time for a second pulse to reach second phase circuitry;
determine a third delay corresponding to an amount of time for a third pulse to reach third phase circuitry, wherein one or more of the first phase circuitry, the second phase circuitry, and the third phase circuitry are located a non-uniform distance from the processor circuitry; and
transmit, based on the first delay, the second delay, and the third delay, the first pulse to the first phase circuitry, the second pulse to the second phase circuitry, and a third pulse to the third phase circuitry such that a first time period between the first pulse and the second pulse is equal to a second time period between the second pulse and the third pulse, wherein:
the first time period is an amount of time between when the first pulse arrives at the first phase circuitry and when the second pulse arrives at the second phase circuitry; and
the second time period is an amount of time between when the second pulse arrives at the second phase circuitry and when the third pulse arrives at the third phase circuitry.

9. The non-transitory machine-readable storage medium of claim 8, wherein the non-uniform distance between the first phase circuitry, the second phase circuitry, and the third phase circuitry to the processor circuitry causes one or more of the first delay, the second delay, and the third delay to be a different value from the other delays.

10. The non-transitory machine-readable storage medium of claim 8, wherein the processor circuitry is configured to:
transmit a zeroth pulse to the first phase circuitry, the zeroth pulse sent before the first pulse;
identify a change in a current sensing pin (CSP) signal from the first phase circuitry, the change proportional to an amperage increase in an output signal caused by the zeroth pulse; and
determine the first delay based on a time difference between the transmission of the zeroth pulse and the identification of the change.

11. The non-transitory machine-readable storage medium of claim 10, wherein the processor circuitry is configured to:
identify the CSP signal corresponding to the first pulse has exceeded an over-current limit;
wait until the CSP signal has fallen below the over-current limit; and
determine, after waiting, when to transmit a fourth pulse to the first phase circuitry based on the first delay, the second delay, and the third delay.

12. The non-transitory machine-readable storage medium of claim 10, wherein the change is a first change, wherein to determine the second delay, the processor circuitry is configured to:
determine the first delay;
approximate the second delay as equal to the first delay when transmitting the first pulse, the second pulse, and the third pulse;
identify a second change in a CSP signal from the second phase circuitry, the second change proportional to an increase in the current of an output signal caused by the second pulse;
update the second delay based on a time difference between the transmission of the second pulse and the identification of the second change; and
use the updated second delay when determining when to transmit additional pulses.

13. The non-transitory machine-readable storage medium of claim 12, wherein the first phase circuitry and the second phase circuitry are located on a same region of a printed circuit board relative to a location of the processor circuitry.

14. The non-transitory machine-readable storage medium of claim 8, wherein the processor circuitry is configured to:
disable, after transmitting the second pulse, the second phase circuitry;
re-enable, an amount of time after disabling, the second phase circuitry;
transmit, based on the first delay, the second delay, and the third delay, a fourth pulse to the first phase circuitry, a fifth pulse to the second phase circuitry, and a sixth pulse to the third phase circuitry;
identify a change in a current sensing pin (CSP) from the second phase circuitry, the change proportional to an increase in the current of an output signal caused by the fifth pulse; and
update the second delay based on a time difference between the transmission of the fifth pulse and the identification of the change; and
use the updated second delay when determining when to transmit additional pulses.

15. A method comprising:
determining, by executing instructions with controller circuitry, a first delay corresponding to an amount of time for a first pulse to reach first phase circuitry;
determining, by executing instructions with the controller circuitry, a second delay corresponding to an amount of time for a second pulse to reach second phase circuitry;
determining, by executing instructions with the controller circuitry, a third delay corresponding to an amount of time for a third pulse to reach third phase circuitry, wherein one or more of the first phase circuitry, the second phase circuitry, and the third phase circuitry are located a non-uniform distance from the controller circuitry; and
transmitting, by executing instructions with the controller circuitry, based on the first delay, the second delay, and the third delay, the first pulse to the first phase circuitry, the second pulse to the second phase circuitry, and a third pulse to the third phase circuitry such that a first time period between the first pulse and the second pulse is equal to a second time period between the second pulse and the third pulse, wherein:
the first time period is an amount of time between when the first pulse arrives at the first phase circuitry and when the second pulse arrives at the second phase circuitry; and
the second time period is an amount of time between when the second pulse arrives at the second phase circuitry and when the third pulse arrives at the third phase circuitry.

16. The method of claim 15, wherein the non-uniform distance between the first phase circuitry, the second phase circuitry, and the third phase circuitry to the controller circuitry causes one or more of the first delay, the second delay, and the third delay to be a different value from the other delays.

17. The method of claim 15, further including:
transmitting a zeroth pulse to the first phase circuitry, the zeroth pulse sent before the first pulse;
identifying a change in a current sensing pin (CSP) signal from the first phase circuitry, the change proportional to an amperage increase in an output signal caused by the zeroth pulse; and
determining the first delay based on a time difference between the transmitting of the zeroth pulse and the identification of the change.

18. The method of claim 17, further including:
identifying the CSP signal corresponding to the first pulse has exceeded an over-current limit;
waiting until the CSP signal has fallen below the over-current limit; and
determining, after waiting, when to transmit a fourth pulse to the first phase circuitry based on the first delay, the second delay, and the third delay.

19. The method of claim 17, further including:
determining the first delay;
approximating the second delay as equal to the first delay when transmitting the first pulse, the second pulse, and the third pulse;
identifying a second change in a CSP signal from the second phase circuitry, the second change proportional to an increase in the current of an output signal caused by the second pulse;
updating the second delay based on a time difference between the transmitting of the second pulse and the identification of the second change; and
using the updated second delay when determining when to transmit additional pulses.

20. The method of claim 15, further including:
disabling, after transmitting the second pulse, the second phase circuitry;
re-enabling, an amount of time after disabling, the second phase circuitry;
transmitting, based on the first delay, the second delay, and the third delay, a fourth pulse to the first phase circuitry, a fifth pulse to the second phase circuitry, and a sixth pulse to the third phase circuitry;
identifying a change in a current sensing pin (CSP) signal from the second phase circuitry, the change proportional to an increase in the current of an output signal caused by the fifth pulse; and
updating the second delay based on a time difference between the transmitting of the fifth pulse and the identification of the change; and
using the updated second delay when determining when to transmit additional pulses.
